(19) United States
(12) Patent Application Publication
(10) Pub. No.: US 2020/0247176 A1
(43) Pub. Date: Aug. 6, 2020

(54) PAINT TRAY AND HANDLE SYSTEMS

(71) Applicant: TRUE PROGRESSION LLC, Portland, OR (US)

(72) Inventors: Tomas Farias, Portland, OR (US); Kevin Troudt, Portland, OR (US)

(21) Appl. No.: 16/676,727

(22) Filed: Nov. 7, 2019

Related U.S. Application Data
(63) Continuation-in-part of application No. PCT/US2018/031748, filed on May 9, 2018.
(60) Provisional application No. 62/503,642, filed on May 9, 2017.

(51) Int. Cl. B44D 3/12; A45F 5/10

(52) U.S. Cl. CPC B44D 3/126; A45F 5/102

(57) ABSTRACT

A combination paint receptacle and handle for lifting and carrying the paint receptacle includes (i) a handle with first and second handle prongs depending from a hand-grip portion and (ii) a substantially rigid paint tray including a bottom wall and four side walls joined to, and extending upwardly from, the bottom wall toward an open receptacle top end. Two opposed side walls extend longitudinally along a tray axis. A top-end periphery defining the open receptacle top end includes at least one outwardly extending receptacle lip extending along each of the opposed side walls, and each receptacle lip has a lip underside. A deviated lip portion with a component of spatial extension perpendicular to the top end periphery is defined along each of the two opposed side walls and has defined therethrough a prong-receiving aperture configured for insertably and removably receiving one of the first and second handle prongs.

### CROSS-REFERENCE TO RELATED APPLICATION/PRIORITY CLAIMS

The present application is a continuation-in-part of International Application Serial No. PCT/US2018/031748 filed May 9, 2018 pursuant to the Patent Cooperation Treaty, and under the title “PAINT TRAY AND HANDLE ASSEMBLY.” Application PCT/US2018/031748 claimed priority benefits in U.S. Provisional Application No. 62/503,642 filed May 9, 2017 under the title “PAINT TRAY AND HANDLE ASSEMBLY.”

The present application claims the benefit of the filing date of Provisional Application Ser. No. 62/503,642, as well as the filing date of PCT Application No. PCT/US2018/031748, based on the priority chain outlined above. Moreover, the entireties of the disclosures, including the drawings, of both previous applications in the aforesaid priority chain are incorporated herein by reference as if set forth fully in the present application.

Although the present application was identified at filing as a “continuation-in-part” application, this identification does not constitute an admission that the present application contains “new matter” not fairly supported in parent Application No. PCT/US2018/031748 or Provisional Application Ser. No. 62/503,642. On the contrary, Applicants' Attorney believes that all aspects of the present application find copious antecedent basis in the applications in which priority is claimed. The limited language added in the present application serves only to clarify or state alternatively disclosures made previously in the priority chain.

### BACKGROUND

Paint trays and paint tray liners are ubiquitous essentials among professional painters and do-it-yourself homeowners alike. A typical paint tray includes a contoured bottom wall from which depends upwardly at least one side wall. The bottom and at least one side wall combine to define a reservoir into which paint to be applied to a surface is poured. The bottom wall is most frequently pitched at an angle that facilitates the migration of paint toward a deeper end of the tray under the force of gravity.

As professional and amateur painters are aware, moving a paint tray containing paint around a worksite, and especially hauling it up a ladder, is difficult at best, and can easily result in spilled paint. Contributing to the difficulty is that the varying depth of the tray, and the freely flowing paint within the tray, result in an unbalanced and unstable load that generally requires two hands to manage.

Accordingly, a need exists for a paint tray and handle assembly that facilitates load balancing and toting around a worksite of an open paint tray containing paint.

### SUMMARY

In one embodiment, a combination paint receptacle and handle assembly for lifting the receptacle includes a paint receptacle defining a paint reservoir configured for temporarily containing liquid paint to be applied to a surface. The receptacle includes a closed bottom wall and at least one side wall joined to, and extending upwardly from, the bottom wall toward an open receptacle top end defined by a top-end periphery. The top-end periphery includes at least one outwardly extending receptacle lip having a lip underside. A handle unit includes a hand-grip portion and first and second prongs depending from the hand-grip portion. The prongs are mutually spaced apart and configured such that each of the prongs can selectively engage at least one lip underside such that a user can lift the paint receptacle by the hand-grip portion.

In a second, more particular embodiment, a paint receptacle is configured as a substantially rigid paint tray. In such a case, the terms “paint receptacle” and “paint tray” may be used interchangeably. The paint tray includes a closed bottom wall and four side walls joined to, and extending upwardly from, the bottom wall toward an open receptacle top end. Two of the four side walls are mutually opposed and extend in parallel along a tray axis spatially situated therebetween.

A top-end periphery defines the open receptacle top end and includes at least one outwardly extending receptacle lip extending along at least a portion of each of the two side walls extending along the tray axis and having a lip underside. Moreover, at least one deviated lip portion is defined by a bend in the receptacle lip along each of the two parallel side walls that extend along the tray axis. Each deviated lip portion has a component of spatial extension perpendicular to the top end periphery. That is to say, each deviated lip portion, while not necessarily fully orthogonal to the top end periphery, is nevertheless non-parallel to the top end periphery.

A handle includes a hand-grip portion from which there depend first and second handle prongs. The first and second handle prongs are mutually spaced apart and substantially parallel. Furthermore, in each of various embodiments, the first and second handle prongs are joined to the hand-grip portion through, respectively, first and second connector portions.

The paint tray is fabricated such that each deviated lip portion has defined therethrough a prong-receiving aperture configured for insertably and removably receiving one of the first and second handle prongs. In this way, the deviated lip portions and associated apertures function as paint-tray retainers that prevent the paint tray from dislodging from the handle prongs when the paint tray and handle are carried by the hand-grip portion.

In one configuration of the paint receptacle (e.g., paint tray), the at least one receptacle lip undulates in order to define a plurality of at least two deviated lip portions along each of the two opposed and parallel side walls that extend along the tray axis. Each of the deviated lip portions has defined therethrough a prong-receiving aperture configured for insertably and removably receiving one of the first and second handle prongs. The prong-receiving apertures of the at least two deviated lip portions along each of the two parallel side walls that extend along the tray axis are aligned along a common prong-aperture axis such that a single one of the first and second handle prongs can be axially and slidably threaded through all of the axially aligned prong-receiving apertures defined along a single one of the two opposed and parallel side walls that extend along the tray axis. This arrangement facilitates retention of the paint tray upon the handle prongs for lifting and carrying of the paint tray by the hand-grip portion.

In each of various versions of the paint tray, the top-end periphery is substantially rectangular in configuration. In at least one such case, the two parallel side walls extending along the tray axis define the longitudinal extent of the paint tray. These two longer side walls are joined by two mutually parallel shorter side walls defining a width extent of the paint tray.

In one illustrative embodiment, the handle is configured with the first and second handle prongs positionally fixed relative to one another, and to the hand-grip portion. Such a handle would be limited for use in conjunction with trays of a particular single width. Accordingly, a handle embodiment configured for use in conjunction with paint trays of various widths is configured such that at least one of the first and second connector portions is pivotably coupled to the hand-grip portion. Thusly configured, the first and second handle prongs can be swung toward and away from one another in order to engage and retain for lifting paint receptacles of various widths.

As previously indicated, and readily appreciable from the context of described use, the paint tray, as a matter of general necessity, is substantially rigid. This does not mean that the paint tray must be fabricated to be totally inflexible under forces exertable by the average person, only that it has a defined shape that it is capable of maintaining when it is filled with paint and lifted by the handle as described. The necessity of substantial rigidity is especially important when the handle implemented is one in which the first and handle prongs can be swung relative to one another since a fixed spatial relationship between the handle prongs in such a case cannot be relied upon to prevent undesirable flex and deformation of the paint tray.

Some versions of the paint tray are fabricated by at least one of stamping and thermal forming a sheet of material. In alternative versions, the sheet of material is one of metal and a polymeric material (e.g., plastic).

Representative embodiments are more completely described and depicted in the following detailed description and the accompanying drawings.

### BRIEF DESCRIPTION OF THE DRAWINGS

FIG. 1 is a perspective view of an illustrative combination paint tray and handle assembly in which the paint tray and handle are separated from one another; and

FIG. 2 is a side view of the combination paint tray and handle assembly of FIG. 1 in which the handle and paint tray are cooperatively joined.

### DETAILED DESCRIPTION

The following description of variously embodied paint tray and handle assemblies is demonstrative in nature and is not intended to limit the invention or its application of uses. Accordingly, the various implementations, aspects, versions and embodiments described in the summary and detailed description are in the nature of non-limiting examples falling within the scope of the appended claims and do not serve to define the maximum scope of the claims.

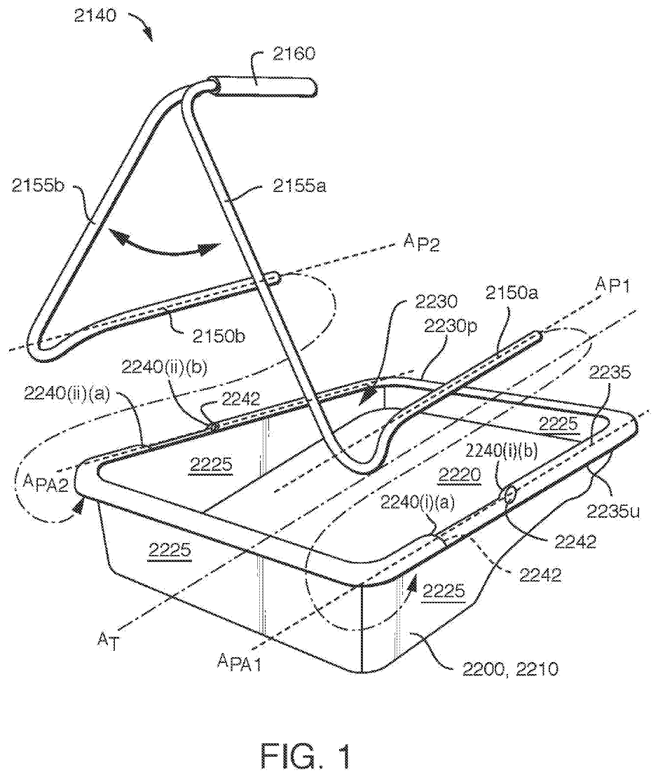

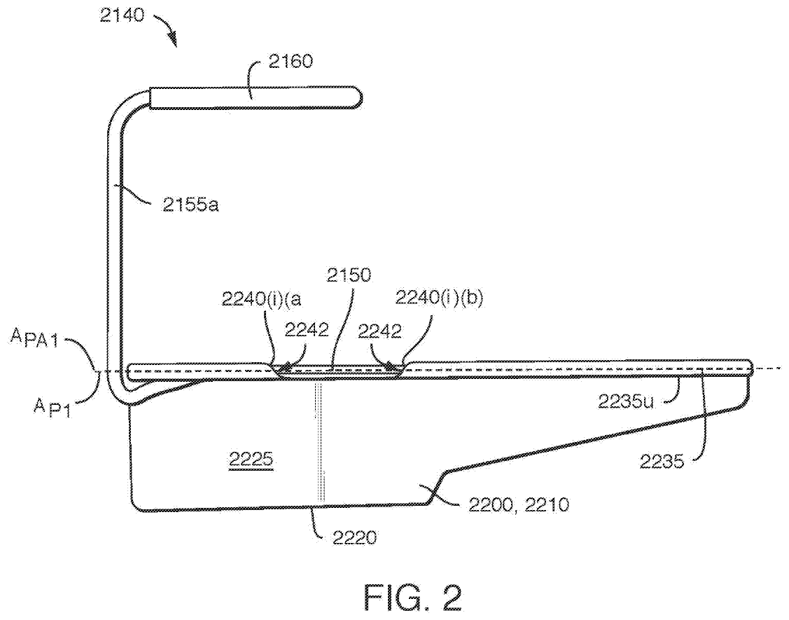

Referring to FIGS. 1 and 2, an illustrative embodiment of a handle 2140 configured for engagement with a paint receptacle 2200 in the form of a paint tray 2110 is shown and described. The paint tray 2210 is, in many respects, of a general and familiar configuration including a contoured closed bottom wall 2220 and four side walls 2225 joined to, and extending upwardly from, the bottom wall 2220 toward an open receptacle top end 2230 defined by a top-end periphery 2230p. The top end periphery 2230p includes an outwardly extending receptacle lip 2235 with a lip underside 2235u. Although the paint tray 2210 could include multiple, separate receptacle lips 2235, the paint tray 2210 in the embodiment illustrated includes a single receptacle lip 2235 that is coextensive with the entire periphery of the receptacle 2200 (paint tray 2210).

While the overall inventive concept is equally applicable to tray-type paint receptacles 2200 of different shapes such as, for example, paint totes with square peripheries, the paint tray 2210 of the illustrative example depicted in FIGS. 1 and 2 has a substantially rectangular top-end periphery 2230p wherein two of the parallel side walls 2225 extend longitudinally along a tray axis A_{T} and are joined by two mutually parallel shorter side walls 2225.

The handle 2140 includes first and second handle prongs 2150a and 2150b extending along, respectively, first and second handle-prong axes A_{P1} and A_{P2}. The first and second handle prongs 2150a and 2150b furthermore depend from a hand-grip portion 2160 through, respectively, first and second connector portions 2155a and 2155b. With each of the handle prongs 2150a and 2150b selectively engaged with a lip underside 2235u of the paint receptacle 2200, the hand-grip portion 2160 is situated above the paint receptacle 2200 and, as viewed downwardly from above (not shown), centered between the two longer parallel walls 2225 such that the hand-grip portion 2160 extends in parallel with the tray axis A_{T}. Although the aforesaid spatial relationship among the handle prongs 2150a and 2150b, the hand-grip portion 2160, and the two longer parallel walls 2225 of the paint receptacle 2200 is not explicitly illustrated as viewed downwardly from above, it can be readily appreciated from FIG. 1, thereby obviating the need to illustrate it specifically.

In the version of FIGS. 1 and 2, the connector portions 2155a and 2155b are pivotably coupled to the hand-grip portion 2160. In this way, the handle prongs 2150a and 2150b can be swung inwardly or outwardly (i.e., respectively, toward and away from one another)—as indicated by the double-headed arcuate arrow—in order to engage the lip underside(s) 2235u of paint receptacles 2200 of various widths. However, while a version in which the handle prongs 2150a and 2150b can be swung inwardly or outwardly is particularly advantageous, it is to be understood that versions in which the handle prongs 2150a and 2150b and their respective connector portions 2155a and 2155b are permanently maintained in fixed positions relative to one another, and to the hand-grip portion 2160, are within the scope and contemplation of the invention. It will be readily appreciated that versions of the latter type would be dedicated to engagement with and lifting of paint receptacles 2200 of a particular width. Because such a version is readily appreciated through examination of the depictions in FIGS. 1 and 2 and could, in fact, appear outwardly indistinguishable therefrom, no additional drawing is provided showing such a version. That is, no additional drawing is required for an understanding of the invention.

Referring still to both FIGS. 1 and 2, described in some detail is the general manner in which the first and second handle prongs 2150a and 2150b engage with the receptacle lip 2235 in order to selectively retain the paint receptacle 2200 on the handle 2140 so that a user can lift the paint receptacle 2200 by the hand-grip portion 2160. In selected locations—in the present case, along the two parallel side walls 2225 extending longitudinally along the tray axis A_{T}—the receptacle lip 2235 bends downwardly from the top-end periphery 2230p toward the tray bottom wall 2220 so as to define a deviated lip portion 2240 having a component of spatial extension perpendicular to the top end periphery 2230p. That is, the receptacle lip 2235 includes a bend to define a deviated lip portion 2240 that, while not necessarily extending fully perpendicular to the top end periphery 2230p, nevertheless extends non-parallel thereto.

When referred to generally in the singular, or collectively in the plural, the deviated lip portion(s) may be referenced in the present description by the more general numeric reference number 2240. However, for clarity, the example of FIGS. 1 and 2 references four distinct deviated lip portions with alphanumeric “extensions” beyond the base reference number “2240.” More specifically two deviated lip portions 2240 corresponding with the first handle prong 2150a are referenced as first-prong first and second deviated lip portions 2240(i)(a) and 2240(i)(b), while two deviated lip portions 2240 corresponding with the second handle prong 2150b are referenced as second-prong first and second deviated lip portions 2240(ii)(a) and 2240(ii)(b).

Each deviated lip portion 2240 has defined therethrough a prong-receiving aperture 2242 configured for insertably and removably receiving one of the first and second handle prongs 2150a and 2150b such that the deviated lip portion 2240 prevents the receptacle lip 2235 from lifting off of the handle prong 2150a and/or 2150b upon or over which the lip underside 2235u is supported. In the particular case represented in FIGS. 1 and 2, the receptacle lip 2235 at the top of each of the two longer parallel side walls 2225 undulates —toward and away from each of the tray bottom wall 2220 and the top-end periphery 2230p as a function of displacement along the tray axis A_{T} in order to define a plurality—two, in this case—of deviated lip portions 2240. On the side of the paint receptacle 2200 configured for engagement with, and support by, the first handle prong 2150a, the undulated receptacle lip 2235 defines, as previously mentioned, first-prong first and second deviated lip portions 2240(i)(a) and 2240(i)(b). Analogously, on the side of the paint receptacle 2200 configured for engagement with, and support by, the second handle prong 2150b, the undulated receptacle lip 2235 defines second-prong first and second deviated lip portions 2240(ii)(a) and 2240(ii)(b).

The prong-receiving apertures 2242 defined through the first-prong first and second deviated lip portions 2240(i)(a) and 2240(i)(b) are mutually aligned along a first-prong-aperture axis A_{PA1}, while the prong-receiving apertures 2242 defined through the second-prong first and second deviated lip portions 2240(ii)(a) and 2240(ii)(b) are mutually aligned along a second-prong-aperture axis A_{PA2}. By these alignments, as seen best in FIG. 1, the first handle prong 2150a can be threaded (axially inserted) through the prong-receiving apertures 2242 of the first-prong first and second deviated lip portions 2240(i)(a) and 2240(i)(b), while the second handle prong 2150b is threaded (axially inserted) through the prong-receiving apertures 2242 of the second-prong first and second deviated lip portions 2240(ii)(a) and 2240(ii)(b). The axial insertion of the first and second handle prongs 2150a and 2050b in the manner described brings the first and second handle-prong axes A_{P1} and A_{P2} into alignment with, respectively, the first-prong-aperture and the second-prong-aperture axes A_{PA1} and A_{PA2}. This respective axial alignment is indicated in idealized fashion in the side view of FIG. 2 in which the first handle-prong axis A_{P1} is indistinguishable from the first-prong-aperture axis A_{PA1}.

With the handle prongs 2150a and 2050b inserted as described above, retention of the paint tray 2210 upon the handle prongs 2150a and 2050b for lifting and carrying of the paint tray 2210 by the hand-grip portion 2160 is facilitated. More specifically, as clearly shown in FIG. 1, because the material (e.g., plastic or metal) defining each deviated lip portion 2240 completely surrounds the prong-receiving aperture 2242 defined therethrough, a handle prong 2150a or 2150b can be inserted into or removed from that prong-receiving aperture 2242 only axially (i.e., along the corresponding handle-prong axis A_{P1} or A_{P2} and, respectively, the corresponding (first or second)-prong-aperture axis A_{PA1} or A_{PA2}). It follows that the manner in which each prong-receiving aperture 2242 is defined by and through a deviated lip portion 2240 does not facilitate lateral insertion and removal of a handle prong 2150a or 2150b, a restriction that serves to prevent unintended dislodgement of the handle prongs 2150a and 2150b from the corresponding prong-receiving apertures 2242 through which they are threaded (axially inserted), while allowing intentional axial removal when desired to discard or change out the paint tray 2210.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A combination paint receptacle and handle assembly for lifting and carrying the paint receptacle comprising:
a paint receptacle configured for temporarily containing liquid paint to be applied to a surface, the receptacle including a closed tray bottom wall and at least one tray side wall joined to, and extending upwardly from, the tray bottom wall toward an open receptacle top end defined by a top-end periphery, the top-end periphery including at least one outwardly extending receptacle lip having a lip underside; and
a handle including a hand-grip portion and first and second handle prongs depending from the hand-grip portion, the handle prongs being mutually spaced apart and configured such that each of the handle prongs can selectively engage at least one lip underside such that a user can lift the paint receptacle by the hand-grip portion, wherein
(a) at least one receptacle lip bends downwardly from the top-end periphery toward the tray bottom wall so as to define a deviated lip portion having a component of spatial extension perpendicular to the top end periphery; and
(b) the deviated lip portion has defined therethrough a prong-receiving aperture configured for insertably and removably receiving one of the first and second handle prongs such that the deviated lip portion prevents the receptacle lip from lifting off of the prong upon which prong the lip underside is supported.

2. The receptacle and handle assembly of claim 1 wherein the at least one receptacle lip undulates in order to define a plurality of at least two deviated lip portions, each of which deviated lip portions has defined therethrough a prong-receiving aperture configured for insertably and removably receiving one of the first and second handle prongs, the prong-receiving apertures of the at least two deviated lip portions being aligned along a common prong-aperture axis such that a single one of the first and second handle prongs can be slidably threaded through all of the prong-receiving apertures, thereby facilitating retention of the paint tray upon the handle prongs for lifting and carrying of the paint tray by the hand-grip portion.

3. The receptacle and handle assembly of claim 2 wherein the paint receptacle is fabricated by at least one of stamping and thermal forming a sheet of material.

4. The receptacle and handle assembly of claim 3 wherein the sheet of material is one of metal and a polymeric material.

5. The receptacle and handle assembly of claim 4 wherein the at least one receptacle lip is a single receptacle lip co-extensive with the entire periphery of the receptacle.

6. The receptacle and handle assembly of claim 5 wherein the top-end periphery is substantially rectangular in configuration.

7. A combination paint receptacle and handle assembly for lifting and carrying the paint receptacle comprising:
a paint receptacle configured as a substantially rigid paint tray for temporarily containing liquid paint to be applied to a surface, the paint tray including a closed bottom wall and four side walls joined to, and extending upwardly from, the bottom wall toward an open receptacle top end, two of the four side walls being mutually parallel and extending along a tray axis spatially situated between the side walls along which the tray axis extends;
a top-end periphery defining the open receptacle top end and including at least one outwardly extending receptacle lip having a lip underside and extending along at least a portion of each of the two side walls that extend along the tray axis;
at least one deviated lip portion defined by a bend in the receptacle lip along each of the two parallel side walls that extend along the tray axis, each deviated lip portion having a component of spatial extension perpendicular to the top end periphery; and
a handle including a hand-grip portion and first and second handle prongs depending from the hand-grip portion, the first and second handle prongs being mutually spaced apart and substantially parallel, wherein
each deviated lip portion has defined therethrough a prong-receiving aperture configured for insertably and removably receiving one of the first and second handle prongs such that the deviated lip portions and associated apertures function as paint-tray retainers that prevent the paint tray from dislodging off of the handle prongs when the paint tray and handle are carried by the hand-grip portion.

8. The paint receptacle and handle assembly of claim 7 wherein the at least one receptacle lip undulates in order to define a plurality of at least two deviated lip portions along each of the two parallel side walls that extend along the tray axis, each of which deviated lip portions has defined therethrough a prong-receiving aperture configured for insertably and removably receiving one of the first and second handle prongs, the prong-receiving apertures of the at least two deviated lip portions along each of the two parallel side walls that extend along the tray axis being aligned along a common prong-aperture axis such that a single one of the first and second handle prongs can be axially and slidably threaded through all of the axially aligned prong-receiving apertures, thereby facilitating retention of the paint tray upon the handle prongs for lifting and carrying of the paint tray by the hand-grip portion.

9. The paint receptacle and handle assembly of claim 8 wherein (a) the top-end periphery is substantially rectangular in configuration and (b) the two parallel walls extending along the tray axis define the longitudinal extent of the paint tray and are joined by two mutually parallel shorter side walls defining a width extent of the paint tray.

10. The paint receptacle and handle assembly of claim 9 wherein (a) the first and second handle prongs depend from the hand-grip portion through, respectively, first and second connector portions and (b) at least one of the first and second connector portions is pivotably coupled to the hand-grip portion such that the handle prongs can be swung toward and away from one another in order to engage and retain for lifting paint receptacles of various widths.

11. The receptacle and handle assembly of claim 10 wherein the at least one receptacle lip is a single receptacle lip co-extensive with the entire periphery of the receptacle.

12. The receptacle and handle assembly of claim 8 wherein the at least one receptacle lip is a single receptacle lip co-extensive with the entire periphery of the receptacle.

13. The receptacle and handle assembly of claim 7 wherein the at least one receptacle lip is a single receptacle lip co-extensive with the entire periphery of the receptacle.
